(19) United States
(12) Patent Application Publication
(10) Pub. No.: US 2023/0172419 A1
(43) Pub. Date: Jun. 8, 2023

(54) Wet Wipe

(71) Applicant: F & S BIOTECH CO., LTD., Taoyuan City (TW)

(72) Inventor: Edward Huang-Chiang Lin, Taipei City (TW)

(21) Appl. No.: 17/693,552

(22) Filed: Mar. 14, 2022

(30) Foreign Application Priority Data
Dec. 3, 2021 (TW) 110145316

(51) Int. Cl. A47L 13/17; B32B 5/26

(52) U.S. Cl. CPC A47L 13/17; B32B 5/268; B32B 5/271; B32B 2432/00

(57) ABSTRACT

A wet wipe which includes a first surface layer, a second surface layer and an absorbent layer is disclosed. The first surface layer has a first outer surface. The second surface layer has a second outer surface. The absorbent layer is arranged between the first surface layer and the second surface layer. A first coefficient of friction of the first outer surface is less than a second coefficient of friction of the second outer surface.

### BACKGROUND OF THE INVENTION

### 1. Field of the Invention

The present invention relates to a wet wipe; more particularly, the present invention relates to a wet wipe which has a variety of textures and usage methods.

### 2. Description of the Related Art

The common wet wipe is composed of a disposable non-woven fabric soaked in alcohol or a cleaning fluid, and the wet wipe is packed in a closed storage bag to allow portability by a user. Portability allows the user to use the wet wipe to clean hands or objects anytime and anywhere, so the wet wipe is popular with consumers.

However, the two sides of the wet wipe of the prior art have the same texture, so the two sides have the same function and method of use.

### SUMMARY OF THE INVENTION

It is an object of the present invention to provide a wet wipe which has a variety of textures and usage methods.

To achieve the abovementioned object, a wet wipe of the present invention includes a first surface layer, a second surface layer and an absorbent layer. The first surface layer includes a first outer surface. The second surface layer includes a second outer surface. The absorbent layer is located between the first surface layer and the second surface layer. A first friction coefficient of the first outer surface is less than a second friction coefficient of the second outer surface.

According to one embodiment of the present invention, the second friction coefficient is between 1.05 and 2 times the value of the first friction coefficient.

According to one embodiment of the present invention, the second friction coefficient is between 1.05 and 1.5 times the value of the first friction coefficient.

According to one embodiment of the present invention, a fiber fitness of the first surface layer is finer than a fiber fitness of the second surface layer.

According to one embodiment of the present invention, a range of the fiber fitness of the first surface layer is 0.2-1.5 denier, and a range of the fiber fitness of the second surface layer is 1.6-10 denier.

According to one embodiment of the present invention, a material of the first surface layer includes paper pulp and meltblown fabric; the weight of the meltblown fabric in the first surface layer accounts for 20%-45% of the total weight of the first surface layer.

According to one embodiment of the present invention, a material of the second surface layer includes paper pulp and meltblown fabric; the weight of the meltblown fabric in the second surface layer accounts for 22% - 65% of the total weight of the second surface layer.

According to one embodiment of the present invention, the weight of the meltblown fabric in the second surface layer is 10%- 40% greater than the weight of the meltblown fabric in the first surface layer so as to cause a difference in friction coefficients.

According to one embodiment of the present invention, the first surface layer and the second surface layer have a difference in friction coefficients due to a height difference produced by embossing.

According to one embodiment of the present invention, a material of the absorbent layer includes at least one of paper pulp, viscose fiber, lyocell fiber, cotton, rayon, polyester fiber and composite fiber.

### BRIEF DESCRIPTION OF THE DRAWINGS

FIG. 1 illustrates a schematic drawing of the wet wipe in a first embodiment of the present invention.

FIG. 2 illustrates a schematic drawing of the wet wipe in a second embodiment of the present invention.

### DETAILED DESCRIPTION OF THE PREFERRED EMBODIMENT

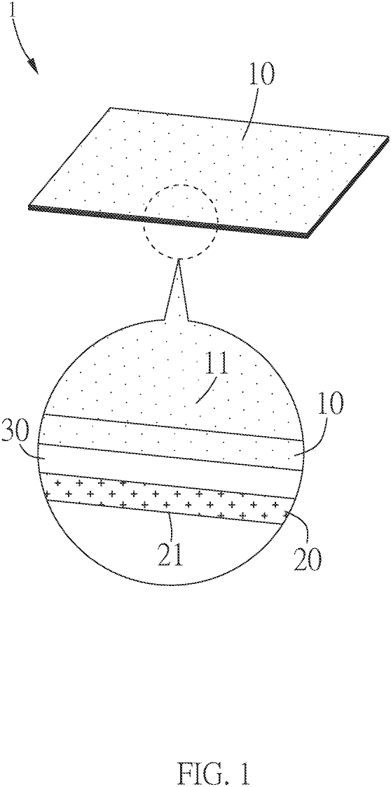

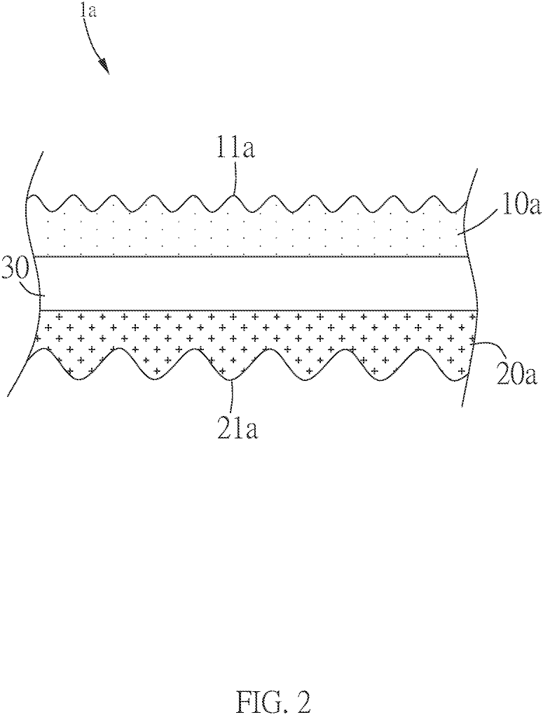

Please refer to FIG. 1 and FIG. 2, which illustrate the wet wipe in one embodiment of the present invention. FIG. 1 illustrates a schematic drawing of the wet wipe in one embodiment of the present invention. FIG. 2 illustrates a schematic drawing of another wet wipe in one embodiment of the present invention.

As shown in FIG. 1, in one embodiment of the present invention, the wet wipe 1 has a variety of textures, and the wet wipe 1 provides a variety of methods of use due to the different textures. The wet wipe 1 includes a first surface layer 10, a second surface layer 20 and an absorbent layer 30.

The absorbent layer 30 is located between the first surface layer 10 and the second surface layer 20. The absorbent layer 30 has an absorbent function for absorbing alcohol, a cleaning fluid, an antiseptic or fragrance additives in advance; thus, when the user uses the wet wipe 1 to wipe an external object, the liquid absorbed in advance by the absorbent layer 30 can be released from the first surface layer 10 and the second surface layer 20 to clean the external object. The material of the absorbent layer 30 includes at least one of paper pulp, viscose fiber, lyocell fiber, cotton, rayon, polyester fiber and composite fiber. However, the material of the absorbent layer 30 is not limited to the abovementioned description, and the material can be changed to another material with the liquid absorbing function according to user requirements. Further, the absorbent layer 30 can also be designed such that no liquid is absorbed in advance, such that the liquid absorbing function of the absorbent layer 30 of the wet wipe 1 can be used to absorb external moisture to achieve a cleaning effect.

The material of the first surface layer 10 includes paper pulp and meltblown fabric, and the weight of the meltblown fabric in the first surface layer 10 accounts for 20% - 45% of the total weight of the first surface layer 10. The first surface layer 10 includes a first outer surface 11, the first outer surface 11 has a first friction coefficient, and the range of the first friction coefficient is 0.2-0.6. The material of the second surface layer 20 includes paper pulp and meltblown fabric, and the weight of the meltblown fabric in the second surface layer 20 accounts for 22%-65% of the total weight of the second surface layer 20. The second surface layer 20 includes a second outer surface 21, the second outer surface 21 has a second friction coefficient, and the range of the second friction coefficient is 0.3-0.8. The first friction coefficient of the first outer surface 11 is less than the second friction coefficient of the second outer surface 21; therefore, the first outer surface 11 has a fine texture, and the second outer surface 21 has a rough texture. Thus, the user can first use the rough-textured second surface layer 20 to exfoliate the skin or to effectively remove dirt and oil from the skin, and then the user can use the finer first surface layer 10 to wipe the skin clean, such that the cleaning effect can be improved.

In one embodiment of the present invention, the second friction coefficient is between 1.05 and 2 times the value of the first friction coefficient; however, the range is not limited to the abovementioned description. In a preferred embodiment, the second friction coefficient is between 1.05 and 1.5 times the value of the first friction coefficient. Due to the different structural designs, the first surface layer 10 and the second surface layer 20 have a difference in friction coefficients. In the present invention, the abovementioned friction coefficients are the coefficient of static friction and applied to the wet wipe 1, which is wet and usable.

The difference in friction coefficients can be caused by many methods. For example, the fiber of the first surface layer 10 is designed to be finer, and the range of the fiber fitness of the first surface layer 10 is 0.2-1.5 denier. The fiber of the second surface layer 20 is designed to be thicker, and the range of the fiber fitness of the second surface layer 20 is 1.6-10 denier. However, the fiber fitness ranges of the first surface layer 10 and the second surface layer 20 are not limited to the abovementioned description; the range can be changed according to user requirements.

Alternatively, the meltblown ratio in the second surface layer 20 can be designed to be greater than the meltblown ratio in the first surface layer 10 so as to cause a difference in friction coefficients via the different material ratios. For example, the weight of the meltblown fabric in the second surface layer can be designed to be 10%-40% greater than the weight of the meltblown fabric in the first surface layer to cause a difference in friction coefficients.

Please refer to the wet wipe 1a illustrated in FIG. 2. The first surface layer 10a and the second surface layer 20a have a difference in friction coefficients due to a height difference caused by embossing. For example, if the first surface layer 10a has no embossing or has embossing with small undulations, the first outer surface 11a will have a finer texture; if the first surface layer 10a does not have embossing and the second surface layer 20a has embossing, the user can easily know which side the rougher surface is by looking at the embossing. Further, the embossing can also be colored to allow a clear distinction. If the first surface layer 10a and the second surface layer 20a both have embossing, then the first surface layer 10a and the second surface layer 20a can be embossed with different patterns or different colors so that the user can discern which side has the rougher surface.

Via the structural design of the wet wipes 1, 1a of the present invention, the two sides of the wet wipes 1, 1a can have different textures to provide the multiple methods of use according to different usage scenarios. The user can use the rougher second surface layer to exfoliate the skin or effectively remove dirt and oil from the skin, and then the user can use the finer first surface layer to wipe the skin clean, such that the cleaning effect is improved.

What is claimed is:

1. A wet wipe, comprising:
a first surface layer, comprising a first outer surface;
a second surface layer, comprising a second outer surface; and an absorbent layer, located between the first surface layer and the second surface layer;
wherein a first friction coefficient of the first outer surface is less than a second friction coefficient of the second outer surface.

2. The wet wipe as claimed in claim 1, wherein the second friction coefficient is between 1.05 and 2 times the value of the first friction coefficient.

3. The wet wipe as claimed in claim 2, wherein the second friction coefficient is between 1.05 and 1.5 times the value of the first friction coefficient.

4. The wet wipe as claimed in claim 1, wherein a fiber fitness of the first surface layer is finer than a fiber fitness of the second surface layer.

5. The wet wipe as claimed in claim 4, wherein a range of the fiber fitness of the first surface layer is 0.2-1.5 denier, and a range of the fiber fitness of the second surface layer is 1.6-10 denier.

6. The wet wipe as claimed in claim 1, wherein a material of the first surface layer comprises paper pulp and meltblown fabric; the weight of the meltblown fabric in the first surface layer accounts for 20% - 45% of the total weight of the first surface layer.

7. The wet wipe as claimed in claim 1, wherein a material of the second surface layer comprises paper pulp and meltblown fabric; the weight of the meltblown fabric in the second surface layer accounts for 22% - 65% of the total weight of the second surface layer.

8. The wet wipe as claimed in claim 1, wherein the first surface layer and the second surface layer have a difference in friction coefficients due to a height difference produced by embossing.

9. The wet wipe as claimed in claim 1, wherein a material of the absorbent layer comprises at least one of paper pulp, viscose fiber, lyocell fiber, cotton, rayon, polyester fiber and composite fiber.
